(19) United States
(12) Patent Application Publication
(10) Pub. No.: US 2024/0087375 A1
(43) Pub. Date: Mar. 14, 2024

(54) TRANSFER LINE AND METHOD FOR DETERMINING THE TIGHTNESS

(71) Applicant: MAGNA Energy Storage Systems GesmbH, Sinabelkirchen (AT)

(72) Inventor: Dirk BOLLE, Grevenbroich (DE)

(21) Appl. No.: 18/357,871

(22) Filed: Jul. 24, 2023

(30) Foreign Application Priority Data
Sep. 12, 2022 (DE) 102022209489.1

(51) Int. Cl. G07C 5/08; F16L 59/065; F16L 59/075

(52) U.S. Cl. CPC G07C 5/0808; F16L 59/065; F16L 59/075; G07C 5/0825

(57) ABSTRACT

A transfer line that includes a process line for transporting a cryogenic fluid, to a motor vehicle, a motor vehicle having such a transfer line, and a computer-implemented method for determining the tightness of the sheath of such a transfer line. The transfer line includes a process line for transporting a cryogenic fluid, a sheath arranged to surround the process line to define an insulation space between the process line and the sheath, one or more temperature sensors arranged on an outer surface of the sheath to detect a current temperature of the sheath; and a control unit operatively connected to the one or more temperature sensors. The control unit has one or more processors and a non-transitory memory operatively coupled to the one or more processors including a set of instructions executable by the one or more processors to cause the control unit to determine, in response to receipt of a signal from the one or more temperature sensors that corresponds to the detected current temperature of the sheath, a tightness of the sheath relative to the process line.

### CROSS-REFERENCE TO RELATED APPLICATIONS

The present application claims priority under 35 U.S.C. § 119 to German Patent Publication No. DE 102022209489.1 (filed on Sep. 12, 2022), which is hereby incorporated by reference in its complete entirety.

### TECHNICAL FIELD

One or more embodiments of this disclosure relates to a transfer line comprising a process line for transporting a cryogenic fluid (e.g., hydrogen) to a motor vehicle, a motor vehicle having such a transfer line, and a computer-implemented method for determining the tightness of the sheath of such a transfer line.

### BACKGROUND

Transfer lines comprising a process line for transporting a cryogenic fluid and a sheath surrounding the process line radially on the outside, in particular, a vacuum sheath, are known per se. Process lines for transporting cryogenic fluids must be thermally insulated from the atmosphere in order to reduce/minimise the input of parasitic heat from the environment into the conveyed medium and to avoid cold spots (risk of injury, oxygen condensation) on surfaces that come into contact with the atmosphere.

A process line is therefore usually integrated into a vacuum sheath and the resulting vacuum space is evacuated. The insulation effect of such a sheath depends on the quality of the vacuum, which inevitably decreases over time or may even already be faulty in its structure. In the line, the vacuum space may also be replaced, for example partly in sub-regions, by a space filled with inert gas, for example in the region of connection points of the transfer line.

Particularly when such a transfer line is used in a motor vehicle, checking the quality of the vacuum or tightness of such a transfer line, or more precisely the vacuum sheath of the transfer line, is very difficult to perform due to the often poor accessibility of the line, for example under the vehicle floor of a heavy goods vehicle or in an additional protective sheath. In mobile applications, in particular, a desired check during travel can be achieved only with difficulty.

### SUMMARY

The one or more embodiments of this disclosure provides a transfer line having an enhanced configuration, a motor vehicle having such a transfer line, and a computer-implemented method for determining the tightness of the sheath of such a transfer line.

In accordance with one or more embodiments, the transfer line facilitates the detection, determination, assessment, monitoring, or measurement of the tightness of the sheath of the transfer line, even in instances where the transfer line is not readily accessible. In particular, it is to be possible to conduct an in situ detection, determination, assessment, monitoring, or measurement of the tightness of the sheath of the transfer line that is installed in a motor vehicle while the motor vehicle is in operation.

In accordance with one or more embodiments, a transfer line comprises a process line for transporting a cryogenic fluid, in particular hydrogen; a sheath surrounding the process line to define an insulation space configured between the process line and the sheath; one or more temperature sensors arranged on the surface of the sheath, the temperature sensor being operatively connected to a control unit at least via a signal line, the control unit being configured to detect, determine, asses, monitor, or measure the tightness of the sheath based on one or more signals of the temperature sensor that correspond to the detected temperature.

In accordance with one or more embodiments, therefore, the detection, determination, assessment, monitoring, or measurement of the quality of vacuum or the tightness of an inserted sheathing region around a process line for cryogenic fluids, or around a corresponding portion of this line, is conducted with the aid of one or more temperature sensors, preferably a plurality of temperature sensors. For this purpose, the temperature sensor or plurality of temperature sensors is/are arranged on the surface of the sheath and are operatively connected to a control unit, such that the control unit can determine the tightness of the sheath in response to receipt of one or more signals transmitted by the temperature sensor(s).

The tightness of the vacuum sheath directly influences the temperature on the outside of the sheath. Conversely, the tightness can be determined based on a detected temperature on the outside of the sheath. Especially when cryogenic medium flows through a previously rather warm line, clear differences in the temperature drop on the outside can be determined with good or bad vacuum, for example, in the case of a first through-flow following installation of the line. As used herein, “arranged on the surface of the sheath” means that the temperature sensor measures the temperature on the surface of the sheath, even should, for example, parts of the sensor are not directly attached to the surface of the sheath. The tightness may be determined, for example, as a binary item of information, i.e., yes/no, or as a tightness value, for example, in a range of values such as, for example, 1 to 10, depending on how severely non-tight the sheath of the transfer line is, and how quickly the vacuum and/or inert gas escapes from the insulation space.

This measurement, or determination, of the tightness can be implemented cost-effectively and, should it be required, can be fully automated. For a mobile application, in particular in a motor vehicle, it is also possible for the measurement to be conducted in situ during operation of the vehicle, during travel and/or when the vehicle is stationary, for example when there is a flow through the line during the filling of a storage system, or refuelling system, connected to the line. Installation faults can occur especially when the system is being constructed, i.e. when the respective line is being connected. These faults can be sensed in an efficient manner to enable a direct shutdown measure to be initiated, and/or they can be indicated.

In accordance with one or more embodiments, the temperature sensor(s) is/are arranged on the outer surface of the sheath, i.e., outside the insulation space.

In accordance with one or more embodiments, the control unit is configured to indicate an item of information regarding the determined tightness or to indicate a warning signal in dependence on the determined tightness. The indication may be given optically/visually and/or acoustically.

In accordance with one or more embodiments, the transfer line has a connector at least at one of its ends, preferably at both ends, the temperature sensor being arranged on the surface of the sheath in the region of the connector, particularly respectively one or more temperature sensors in the region at each of the two connectors. The temperature sensor(s) may also be arranged on the surface of the sheath between the two ends of the transfer line, in particular, arranged approximately centrally or at regular intervals along the transfer line. The temperature sensor(s) may also be arranged in a particular axial portion of the transfer line, for example in order to monitor this axial portion.

The insulation space may comprise a vacuum space and/or an inert gas space and/or a multi-layer insulation (MLI) space, so may for example have a vacuum, be filled with inert gas and/or have multi-layer insulation (MLI).

In accordance with one or more embodiments, a motor vehicle comprises a transfer line as set forth and described herein, the transfer line being installed in the motor vehicle. Preferably one end of the transfer line is connected via a coupling or connector, to a cryogenic tank, in particular, a hydrogen tank. The transfer line may be installed, for example partially, in a position of the motor vehicle that is difficult to access, for example, underneath a vehicle floor.

In accordance with one or more embodiments, the transfer line is arranged, at least partly, in a protective sheath arranged radially outside the sheath. The control unit may be configured to determine the tightness of the sheath based on receipt of the signal transmitted by the temperature sensor during operation of the motor vehicle. The determination of the tightness may alternatively or additionally also be conducted when the motor vehicle is at a standstill.

In accordance with one or more embodiments, a computer-implemented method for determining the tightness of the sheath of such a transfer line comprises detecting a current temperature of the sheath; transmitting a signal that represents the detection of the current temperature; and determining, in response to receipt of the signal, the tightness of the sheath.

In accordance with one or more embodiments, a computer-implemented method for determining the tightness of the sheath of such a transfer line comprises successively detecting a current temperature of the sheath over a period of time; transmitting one or more signals that represent the detections of the current temperature of the sheath; and determining, in response to receipt of the one or more signals, the tightness of the sheath.

Thus, the tightness of the sheath can be based on one temperature measurement or a plurality of temperature measurements that are conducted successively over time. For example, a lack of tightness of the transfer line may be determined from a low measured temperature or from a falling temperature characteristic of a plurality of temperature measurements.

### DRAWING

One or more embodiments of this disclosure will be illustrated by way of example in the drawings and explained in the description hereinbelow.

FIG. 1 illustrates a schematic sectional view of a transfer line, in accordance with one or more embodiments.

### DESCRIPTION

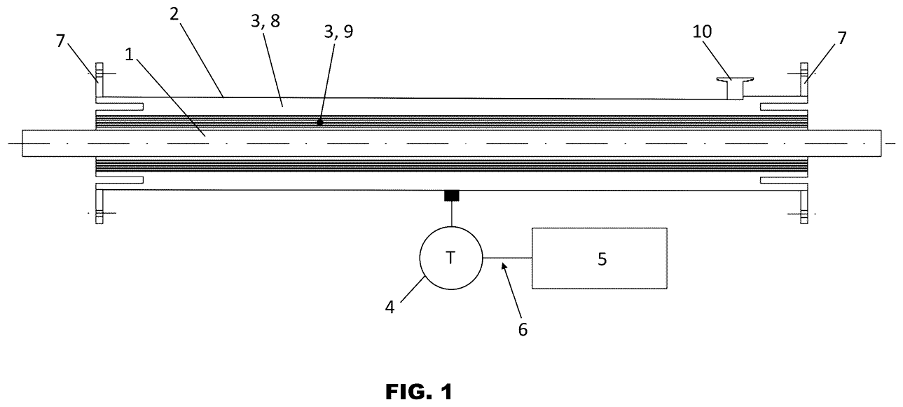

Represented in FIG. 1 is a transfer line in accordance with one or more embodiments. The transfer line comprises a process line 1 for transporting a cryogenic fluid, in particular hydrogen, and a sheath 2, in particular, a vacuum sheath, that surrounds the process line 1 radially on the outside and extends at least partly along the process line 1. A vacuum space defined between the process line 1 and the sheath 2, includes an insulation space 3 arranged therein which likewise extends at least partly along the process line 1.

The transfer line is designed to be installed in a motor vehicle, for example, in a protective sheath arranged radially outside the sheath 2. In the insulation chamber 3 there is a vacuum 8, as well as a multi-layer insulation (MLI) 9. The vacuum 8 may be generated via a vacuum nozzle 10. The transfer line has connectors 7 at both ends, in particular couplings, for example for interfacing to a hydrogen tank of a motor vehicle and also to a tank for filling the motor vehicle tank. A plurality of temperature sensors 4 may be arranged between the two ends of the transfer line, for example in different portions of the transfer line and/or at the connectors 7.

One or more temperature sensors 4 is/are arranged on an outer surface of the sheath 2 and operatively connected to a control unit 5 via a signal line 6. The control unit 5 may comprise an electronic or engine control unit (ECU). The control unit 5 may comprise one or more processors. As set forth, described, and/or illustrated herein, “processor” means any component or group of components that are operable to execute any of the processes described herein or any form of instructions to carry out such processes or cause such processes to be performed. The processors may be implemented with one or more general-purpose and/or one or more special-purpose processors. The processors 21 may comprise at least one hardware circuit (e.g., an integrated circuit) operable to carry out instructions contained in program code. Examples of suitable processors include graphics processors, microprocessors, microcontrollers, DSP processors, and other circuitry that may execute software (e.g., stored on a non-transitory computer-readable medium). Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processors 21 may comprise at least one hardware circuit (e.g., an integrated circuit) operable to carry out instructions contained in program code. In embodiments having a plurality of processors, such processors may work independently from each other, or one or more processors may work in combination with each other.

The control unit 5 is configured to determine the tightness of the sheath 2 based on receipt of one or more signals transmitted by the temperature sensor 4. In essence, the control unit 5 is configured to determine at least whether the sheath 2 is currently tight or not, and/or a degree of tightness. The control unit 5 may output an optical/visual and/or acoustic warning regarding the tightness, for example, in the form of an alarm signal, and/or forward it to at least one further control device of the motor vehicle for further processing.

In accordance with one or more embodiments, therefore, one or more temperature sensors 4 may thus be used for surface temperature measurement of vacuum sheaths 2 or inserted sheathing regions of transfer lines for cryogenic fluids as an indicator of the quality of vacuum, or tightness. A computer-implemented method is specified for indirectly assessing the tightness of the relevant line portions from the temperature behaviour recorded by the sensors.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 process line
2 sheath
3 insulation space
4 temperature sensor
5 control unit
6 signal line
7 connector
8 vacuum
9 multi-layer insulation
10 vacuum nozzle

What is claimed is:

1. A transfer line for a motor vehicle, the transfer line comprising:
a process line for transporting a cryogenic fluid;
a sheath arranged to surround the process line to define an insulation space between the process line and the sheath;
one or more temperature sensors arranged on an outer surface of the sheath to detect a current temperature of the sheath; and
a control unit operatively connected to the one or more temperature sensors, the control unit having one or more processors and a non-transitory memory operatively coupled to the one or more processors comprising a set of instructions executable by the one or more processors to cause the control unit to determine, in response to receipt of a signal from the one or more temperature sensors that corresponds to the detected current temperature of the sheath, a tightness of the sheath relative to the process line.

2. The transfer line of claim 1, wherein the set of instructions are executable by the one or more processors to cause the control unit to indicate, in response to determining the tightness of the sheath relative to the process line, an item of information regarding the determined tightness.

3. The transfer line of claim 1, wherein the set of instructions are executable by the one or more processors to cause the control unit to transmit, in response to determining the tightness of the sheath relative to the process line, an optic warning signal.

4. The transfer line of claim 1, wherein the set of instructions are executable by the one or more processors to cause the control unit to transmit, in response to determining the tightness of the sheath relative to the process line, an acoustic warning signal.

5. The transfer line of claim 1, wherein:
the process line has a connector arranged at least at one end thereof, and
the one or more temperature sensors are arranged on the outer surface of the sheath in a region of the connector.

6. The transfer line of claim 5, wherein the one or more temperature sensors are arranged on the outer surface of the sheath between two ends of the process line.

7. The transfer line of claim 1, further comprising a vacuum arranged in the insulation space.

8. The transfer line of claim 1, further comprising an inert gas arranged in the insulation space.

9. The transfer line of claim 1, further comprising a multi-layer insulation arranged in the insulation space.

10. The transfer line of claim 1, wherein the set of instructions are executable by the one or more processors to cause the control unit to determine the tightness of the sheath relative to the process line during operation of the motor vehicle.

11. A motor vehicle, comprising:
a transfer line installed in the motor vehicle, the transfer line having one end thereof fluidically connected to a cryogenic tank, the transfer line including:
a process line for transporting a cryogenic fluid,
a sheath arranged to surround the process line to define an insulation space between the process line and the sheath,
one or more temperature sensors arranged on an outer surface of the sheath to detect a current temperature of the sheath, and
a control unit operatively connected to the one or more temperature sensors, the control unit having one or more processors and a non-transitory memory operatively coupled to the one or more processors comprising a set of instructions executable by the one or more processors to cause the control unit to determine, in response to receipt of a signal from the one or more temperature sensors that corresponds to the detected current temperature of the sheath, a tightness of the sheath relative to the process line.

12. The motor vehicle of claim 11, further comprising a protective sheath arranged radially outside the sheath.

13. The motor vehicle of claim 11, wherein the set of instructions are executable by the one or more processors to cause the control unit to indicate, in response to determining the tightness of the sheath relative to the process line, an item of information regarding the determined tightness.

14. The motor vehicle of claim 11, wherein the set of instructions are executable by the one or more processors to cause the control unit to transmit, in response to determining the tightness of the sheath relative to the process line, an optic warning signal.

15. The motor vehicle of claim 11, wherein the set of instructions are executable by the one or more processors to cause the control unit to transmit, in response to determining the tightness of the sheath relative to the process line, an acoustic warning signal.

16. The motor vehicle of claim 11, further comprising a vacuum arranged in the insulation space.

17. The motor vehicle of claim 11, further comprising an inert gas arranged in the insulation space.

18. The motor vehicle of claim 11, further comprising a multi-layer insulation arranged in the insulation space.

19. The motor vehicle of claim 11, wherein the set of instructions are executable by the one or more processors to cause the control unit to determine the tightness of the sheath relative to the process line during operation of the motor vehicle.

20. A computer-implemented method, comprising:
detecting a current temperature of a sheath arranged to surround a process line configured to transport a cryogenic fluid; and
determining, based on the detected current temperature, the tightness of the sheath relative to the process line.
